(19) United States
(12) Patent Application Publication
(10) Pub. No.: US 2014/0356163 A1
(43) Pub. Date: Dec. 4, 2014

(54) TURBOMACHINE

(71) Applicant: T-Wind GmbH, Wien (AT)

(72) Inventor: Meinhard Schwaiger, Linz (AT)

(21) Appl. No.: 14/369,851

(22) PCT Filed: Dec. 27, 2012
(86) PCT No.: PCT/EP2012/076954

§ 371 Date: Jun. 30, 2014

(30) Foreign Application Priority Data
Dec. 29, 2011 (AT) A 1904/2011

(51) Int. Cl. F03D 3/06

(52) U.S. Cl. CPC F03D 3/068; F05B 2270/321
USPC 416/1; 416/147

(57) ABSTRACT

An alternative apparatus for utilizing wind and water energy on the basis of a cyclogyro rotor, which may be arranged as a small-size power plant, with increased efficiency and extended application spectrum. A turbomachine includes a substantially cylindrical rotor with the rotor body and a rotational axis, in which the rotor is arranged to be permeated in a direction perpendicularly to the rotational axis, and has a plurality of rotor blades arranged parallel to the rotational axis in the rotor body and an adjusting device for cyclically adjusting the rotor blades.

### CROSS-REFERENCE TO RELATED APPLICATIONS

The present application is a National Stage Application of PCT International Application No. PCT/EP2012/076954 (filed on Dec. 27, 2012), under 35 U.S.C. §371, which claims priority to Austrian Patent Application No. A 1904/2011 (filed on Dec. 29, 2011), which are each hereby incorporated by reference in their respective entireties.

### TECHNICAL FIELD

The present invention relates to an alternative apparatus for utilizing wind and water energy on the basis of a cyclogyro rotor, preferably arranged as a small-size power plant, with increased efficiency and extended application spectrum.

The invention specifically relates to a turbomachine, comprising a substantially cylindrical rotor with the rotor body and a rotational axis, wherein the rotor is arranged to be permeated in a direction perpendicularly to the rotational axis, and comprising several rotor blades arranged parallel to the rotational axis in the rotor body and an adjusting device for cyclically adjusting the rotor blades.

### BACKGROUND

Power generation from renewable energy sources is gaining in importance all over the world. Concepts with a horizontal rotational axis or vertical rotational axis are known for wind power plants, which are arranged as windmills or vertical axis rotors (Darrieus rotor). The wing profiles are predominantly arranged as lift profiles. Wind power plants are either erected as large installations in wind farms, for which purpose much effort is invested in the electricity network infrastructure in addition to the high erection costs, or as decentralized small-size installations whose erection costs and expenditures for the infrastructure are relatively lower. Wind as a power source is available in Europe for approximately 4000 hours per year, wherein the wind velocity extends over a wide spectrum which can be described approximately by a Weibull distribution, with a maximum frequency in the range of approximately 2 to 8 m/s. The wind power plants remain deactivated as a result of an inadequate power yield beneath a critical wind speed (start-up speed or coupling speed).

Power generation from solar power is possible in Europe for approximately 1700 hours per year, which is why the annual total yield in power in photovoltaic installations is rather limited. The unfavorable frequency distribution of the wind velocity and the inconsistent wind directions have a disadvantageous effect on the operation of conventional wind power plants, and the comparatively low number of useful hours of sunshine have a disadvantageous effect on photovoltaic installations.

Various efforts have been made to improve the energy yield in wind power plants. These include the optimization of the wing geometry by way of winglets in windmills for example, the increase in efficiency of which is only a few percent, the integration of small wind power plants in roof constructions or flow-related apparatuses for wind amplification.

A horizontal wind power plant is known from German Patent Publication No. DE 2914957 A1 (R. H. Illig, 1979), whose rotor is arranged with fixed wing elements and is encapsulated completely in a housing having a flap system which allows incident flow against the rotor wings of only one half of the rotor. The incident flow of the rotor can thus occur from only two preferred wind directions. The enclosure is integrated as a separate cuboid housing or in the roof ridge following the shape of the roof.

A wind power plant is known from Austrian Patent Publication No. AT 393.399 B (M. Rettenbacher, 1985), which is permeated transversely to the rotational axis and is arranged with flexible sail surfaces. The sail surface is fixedly anchored on one side and connected on the second side to a cross member in the rotor which performs a circular movement with the radius R. During a rotation of the rotor, the sail surface is thus virtually tensioned once (the cross member is situated opposite the fixed sail surface anchoring) or bulges in a loop-like fashion in the wind. Three units are placed in succession along a common rotational axis offset by an angular pitch of 120°. The efficiency of the installation is rather limited.

A horizontal wind power plant with a wind guide device, which is integrated in the gable construction of a roof, is known from German Patent Publication No. DE 19644890 A (R. Huber, 1998), whose rotor is arranged with rigid flat radial rotor wings and is integrated in the recess of the roof gable in such a way that the wind only flows against the upper part of the “roll rotor.” The cover element is used as a wind guide device and for snow and rain protection.

A wind power plant for roofs for power generation is known from German Patent Publication No. DE 10054815 A (J. Kramer, 2000), wherein the windmill, which is arranged as a cross-flow fan, and the generator are an integral component of a roof ridge cover. This roof ridge cover consists of movable wind guide plates.

A wind power plant on the basis of a Darrieus rotor is known from European Patent Publication No. EP 1 422 422 A2 (Takahashi, 2002), whose rigid rotor blades are provided with a wing profile which is arranged in the manner of a pocket and is open on one side for increasing the wind yield in the case of low wind speeds.

A wind or water turbine is known from Great Britain Patent Publication No. GB 2396888 A (Mackinnon Calum, 2004), which is permeated with air or water transversely to the rotor axis and is arranged with planar radial rotor blades. The medium of air or water is guided by a special flow guide device to a rotor half, so that the rotor can be made to rotate. The flow medium is partly conveyed back against the direction of flow by the reversely revolving rotor blade. The efficiency remains very low.

A vertical-axis wind power plant is known from Great Britain Patent Publication No. GB 2440946 B (P. P. Robertson, 2006), which is mounted on the roof of a house, which guides the incoming air to the vertical-axis turbine which is situated beneath by way of a special flow guide device, and which is provided with a flap valve controlling the air quantity in order to keep the speed constant over a wide wind velocity range.

A highly efficient turbine for the utilization of wind power and hydropower is known from WO Patent Publication No. 2008/127751 A (O. Akcasu, 2008), which is arranged as a cyclogyro rotor with a aerodynamically shaped rotor blades which can be pivoted by in a computer-controlled fashion about a pivoting axis parallel to the rotational axis of the rotor. The pitch angle of the rotor blades is thus aligned in a permanently optimized manner during a full rotation of the rotor in the direction of flow of the wind flow or water flow.

A horizontal wind power plant with rigid wing geometry is known from U.S. Patent Publication No. 2009/102197 A1 (T. Alabarte, 2008), which is provided with a special wind guide device in order to enable influencing the effective flow velocity of the wind flow to a more constant rotor speed. Furthermore, the wind guide devices are arranged as planar photovoltaic panels.

A further vertical wind turbine with fixed rotor blades is known from U.S. Patent Publication No. US 2010/0013233 A (B. A. Buhtz, 2008), which is provided for low wind velocities and does not comprise any azimuth adjusting device.

A horizontal wind power plant with fixed wing geometry is known from German Patent Publication No. DE 202008014689 U1 (J. Torber, 2008), which is integrated in the roof ridge of houses and whose upper half is completely encapsulated and comprises two generators for power generation.

A vertical wind power plant with half-shell-shaped rigid rotor blades is known from WO Patent Publication No. 2010/107289 A (M. S. Lee, 2009), which is arranged as a displacement rotor and is arranged on a disc.

A horizontal wind power plant with planar rotor blades (displacement rotor) is known from Great Britain Patent Publication No. GB 2470501 A (Fu-Chang Liao, 2010), which is arranged with a special guide device for focusing the wind flow to only one half of the rotor and with a rotary apparatus for readjusting the wind power plant in the wind direction (azimuth adjustment).

An apparatus for utilizing wind energy is known from German Patent Publication No. DE 102010015673 A (W. Odenwald, 2011), which is integrated in the roof ridge of a house and is arranged with a plurality of rigid wings which are arranged on the circumference of a cylinder. A portion of the circumference is covered by the roof construction, so that approximately half the rotor cross-section is accessible to the inflow of air. A portion of the air flow is conveyed back against the wind direction.

U.S. Pat. No. 6,379,115 B discloses a flow machine with the features of the preamble of claim 1.

The relatively low efficiency and the comparatively high necessary coupling velocity at which the wind power plant or hydroelectric power plant is made to rotate automatically have a disadvantageous effect in these known concepts.

### SUMMARY

It is the object of the present invention to substantially expand the range of flow velocities that can be utilized by way of a novel turbine construction, to increase the efficiency at low flow velocities and to increase the energy yield in total.

This object is achieved in accordance with the invention by an apparatus of the kind mentioned above through the features of an adjusting device having a first operating mode in which the rotor blades are cyclically pivoted in their entirety, and a second operating mode in which the sections of the rotor blades are pivoted cyclically against each other.

It is provided in particular that the rotor blades consist of two sections which can be pivoted about a pivot axis which is parallel to the rotational axis. This means that for generating power from an air or water flow a special rotor according to the principle of a cyclogyro rotor is used whose rotor blades can have two different wing shapes depending on the inflow velocity. In a cyclogyro rotor, the rotor blades are pivotably arranged along a rotational axis about a cyclic pitch angle. This pitch angle is usually up to +/−45°, preferably up to +/−35°.

During a full rotation of 360° of the rotor about the rotor axis, the rotor blades are moved cyclically about the pivot angle from the negative to the positive maximum value, wherein there is twice a neutral pivot angle and once each a maximum positive and maximum negative pivot angle. It is influenced via an integrated offset triggering in which rotary position to the direction of flow there will be a neutral pivot angle or a maximum negative or positive pivot angle. Maximum energy yield can be obtained when the neutral pivot angles are aligned as parallel as possible to the direction of flow and the maximum negative or positive pivot angles are aligned optimally in the flow. A complex local flow condition is obtained by superimposing the circumferential speed and the inflow speed of the flow medium, and an aerodynamic angle of inflow is produced from the pivot angle which provides the rotor blade with an aerodynamic lifting force and produces a torque via the distance radius from the rotor rotational axis which makes the rotor rotate. Although the local flow conditions around the rotor blade are different at each rotational angle during a complete rotation of the rotor, they produce a virtually constant torque progression at a number of rotor blades that consists of 6 pieces. Such rotors start to rotate from a specific flow velocity, which is known as coupling or start-up speed.

In order to reduce this minimum required flow velocity and to increase the energy yield at low flow velocities, it is proposed in a first preferred embodiment to arrange the rotor blades as a “morphing wing.” The rotor blade is preferably a fully symmetric profile which can be folded up along the axis of symmetry from the rear edge to the profile nose. This leads to two profile half bodies which produce a high flow resistance in the event of respective incident flow. The rotor blade that runs back is closed and offers an only very low flow resistance. As a result, the rotor blade moving in the direction of flow is folded up and produces a high flow resistance, and the rotor blade that runs back against the direction of flow is closed and offers an only very low flow resistance. The rotor blade thus becomes a resistance rotor at low to medium flow velocities. The rotor blades remain closed at higher flow velocities and the rotor becomes a lifting rotor.

The pivotable sections preferably lie in a first position in a compact fashion on each other and form the wing profile as described above. The two sections are folded up in a second position, so that the cross-section which is exposed in relation to the flow is multiplied. The two sections thus form a bucket in the form of a two-dimensional Pelton bucket, i.e., the cross-section corresponds approximately to a section of a cardioid. This optimizes the inflow behavior in displacement operation. The pivot angle of the two sections from the compact position to the position formed in the manner of a bucket is typically between 135° and 180°, but should be at least 90°. This pivot angle is preferably divided approximately evenly among the two sections.

The turbomachine in accordance with the invention can be illustrated advantageously as a part of a hydroelectric power plant, in which the rotor is arranged in an exposed fashion on the floor of a flowing water body. A grating is optionally provided around the rotor which prevents collisions by floating objects. It is also possible to cover the rotor at least partly towards the top.

On the other hand, the turbomachine can also be arranged as a part of a wind power plant, wherein preferably the arrangement is provided on the roof of a building. In order to increase the inflow velocity, an inflow cone can be provided in an especially preferred way upstream of the rotor and a diffuser downstream of the rotor.

It is proposed in a preferred embodiment to increase the energy yield that the inflow velocity in the rotor intake is increased by way of a flow guide apparatus. The energy yield of rotors with flow around said rotors rises for physical reasons to the third power of the inflow velocity. In the case of small-size wind power plants, the integration of the wind power plant in the roof construction of a building, e.g. in the gable, can be considered. The inclined roof surface and the building wall of an average one-family house can approximately increase the flow velocity of the air flow depending on the geometric conditions by a factor of 1.25 to 2, thus leading to an increase in the energy yield by the factor 1.95 to 8. An arrangement of wind power plants on high-rise buildings, preferably in the region of the roof edges of high-rise buildings or flat roofs of high-rise or office buildings, also allows a significant acceleration in the flow velocity and an increase in the energy yield of such wind power plants.

Further advantages over conventional horizontal wind power plants are provided by the compact dimensions, the integrated protective housing of the rotating parts, the lower noise level and the avoidance of the “travelling shadow” of the moved conventional rotor blades.

In small-size hydroelectric power plants according to the rotor conception in accordance with the invention, the energy yield at low flow velocities, as prevail for example in flowing water bodies without damming, is achieved on the one hand by using rotor blades with a “morphing wing” design and on the other hand by a purposeful increase in the local inflow velocity by way of an apparatus arranged with respect to its flow design. It preferably consists of an inlet region which constricts in the manner of a funnel, which produces an increase in the flow velocity, and a rapidly widening outlet region which produces a decrease in pressure in the mass flow at the outlet from the rotor.

The invention further relates to a method for operating a turbomachine of the kind mentioned above. Such a method provides that the inflow moves against a rotor transversely to its rotational axis, wherein the rotor blades are adjusted cyclically during the rotation. In particular, this adjustment shall occur at least partly by cyclic folding up and folding down of two sections forming the rotor blades.

This method can be arranged in two different embodiments. In a first preferred embodiment of this method, changeover is carried out between two operating modes depending on the flow velocity. The cyclic folding up and folding down of the sections that form the rotor blades occurs at low inflow velocity. At higher flow velocities, the cyclic adjustment of the rotor blades is carried out in a second operating mode by a pivoting movement, in which the profile as such is maintained however. It is also possible to perform the adjustment in a manner controlled by centrifugal force depending on the rotor speed.

In an alternative embodiment of the method, a pivoting movement of the rotor blades can be performed simultaneously with the folding up and folding down.

### DRAWINGS

The invention will be described below in closer detail by reference to the embodiments illustrated as follows.

FIG. 1 illustrates a cyclogyro rotor in accordance with the invention in a first operating mode in an isometric view.

FIG. 2 illustrates a side view the cyclogyro rotor of FIG. 1 in the direction of flow.

FIG. 3 illustrates a side view the cyclogyro rotor of FIG. 2.

FIG. 4 illustrates in a sectional view along the line B-B of FIG. 2 the cyclogyro rotor with closed wing profiles.

FIG. 5 illustrates the cyclogyro rotor with open wing profiles in a quadrant in a sectional view.

FIG. 6 illustrates an isometric view of the cyclogyro rotor with open wing profiles in a quadrant.

FIG. 7 illustrates an isometric view of an embodiment of a building with a wind accelerator in the gable region.

FIG. 8 illustrates an isometric view of a variant of the building with a wind accelerator and the progression of the flow lines.

FIG. 9 illustrates an embodiment of the cyclogyro rotor in a horizontal axial alignment.

FIG. 10 illustrates a horizontal embodiment of the cyclogyro rotor as a wind power plant integrated in the gable construction of a building and combined with photovoltaic or solar panels.

FIG. 11 illustrates the cyclogyro rotor of FIG. 10.

FIG. 12 illustrates an embodiment of a horizontal wind power plant on a flat roof.

FIG. 13 illustrates a vertical embodiment of the cyclogyro rotor as a wind power plant integrated in the gable construction of a building.

FIG. 14 illustrates the cyclogyro rotor of FIG. 13.

FIG. 15 illustrates an arrangement of the vertical embodiment as a wind power plant with protective housing on a building with a flat roof

FIG. 16 illustrates an embodiment of the cyclogyro rotor as a hydroelectric power plant in a front view.

FIG. 17 illustrates a sectional view the cyclogyro rotor as a wind power plant.

FIG. 18 illustrates in an isometric view an embodiment of the cyclogyro rotor as a wind power plant.

### DESCRIPTION

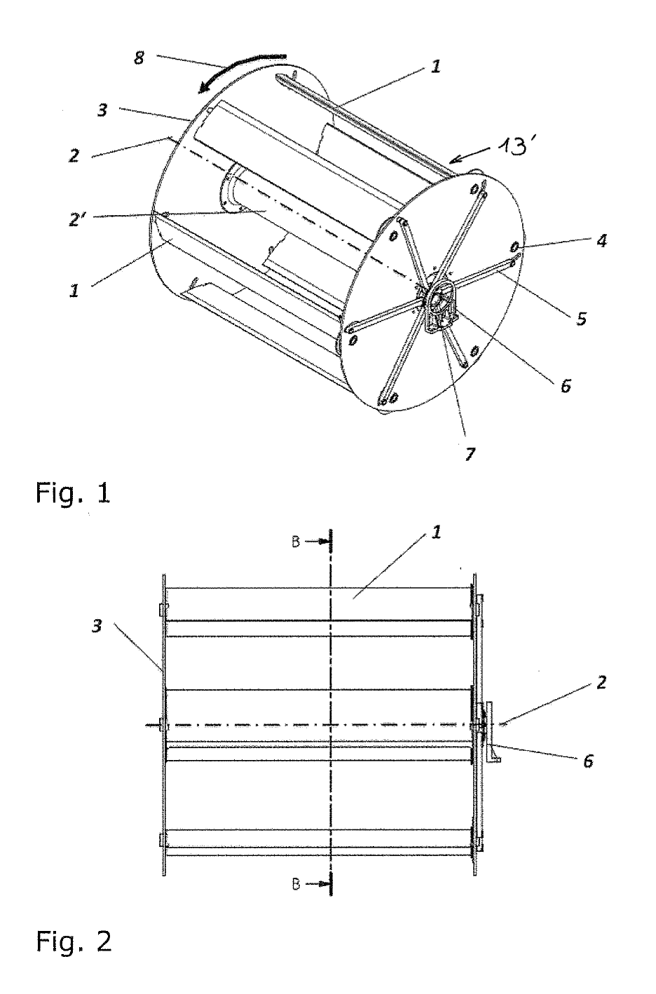

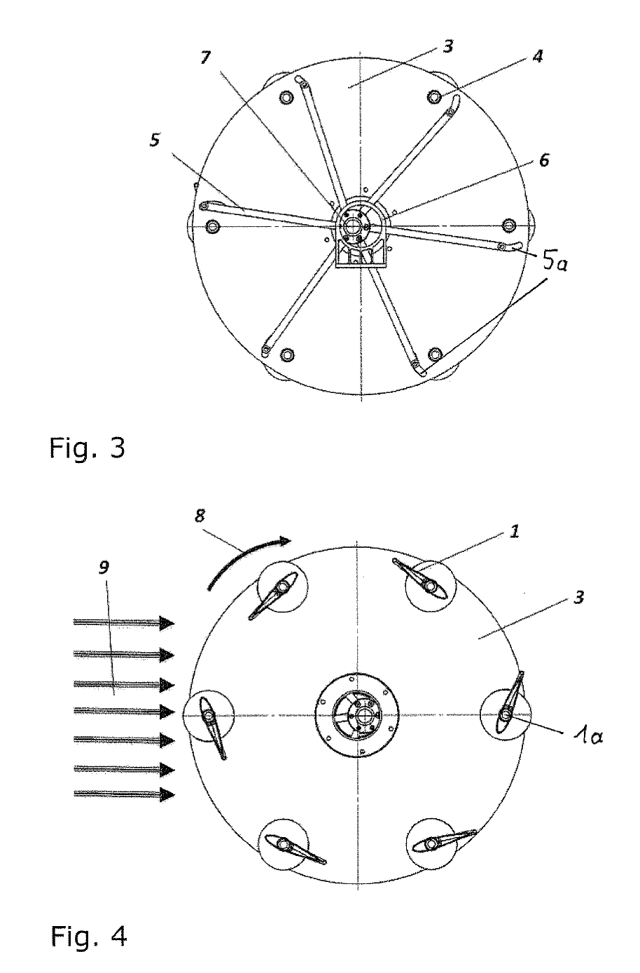

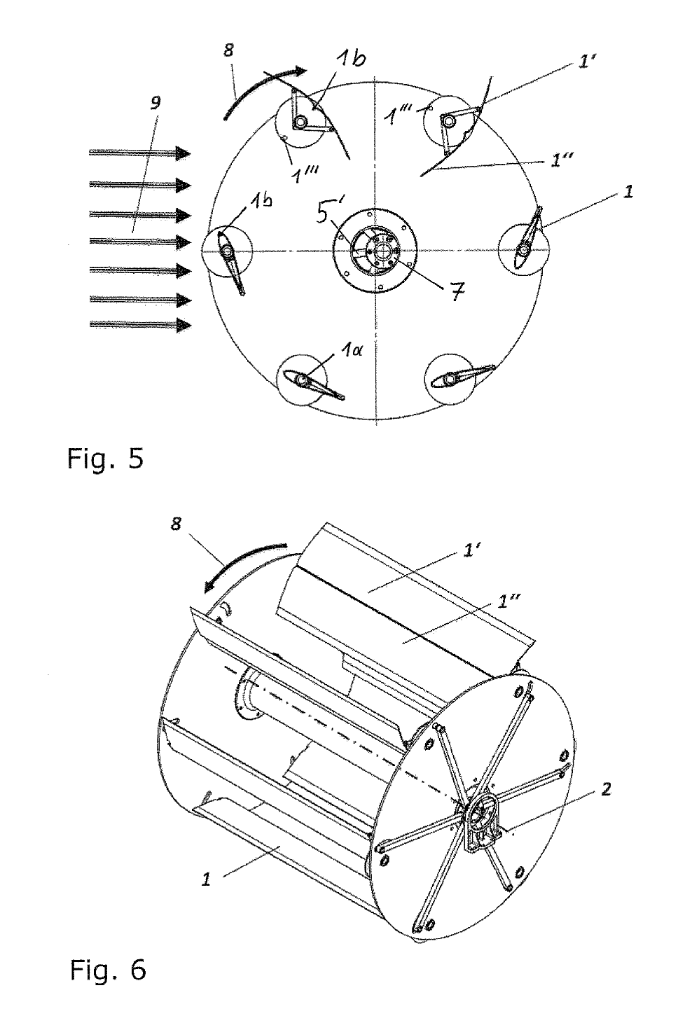

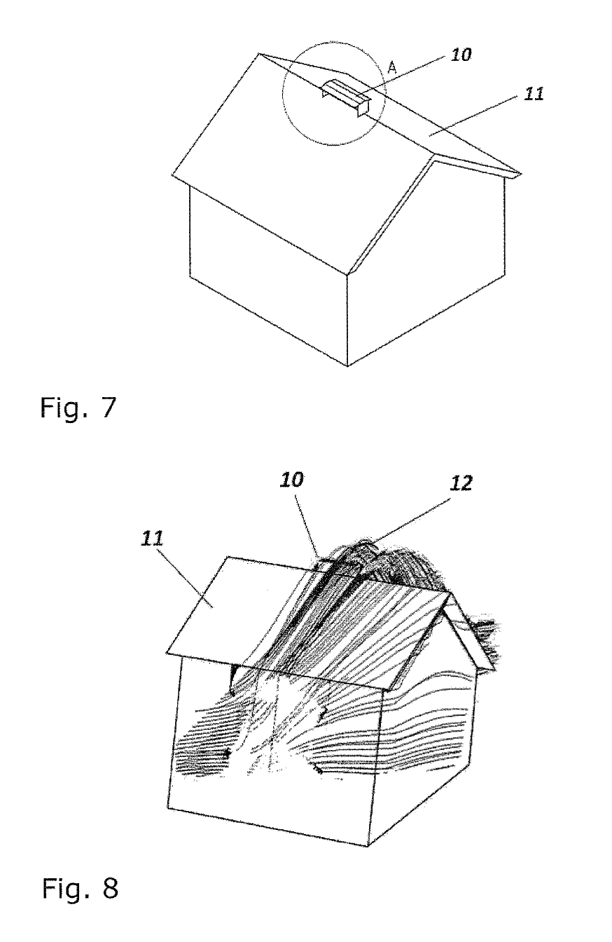

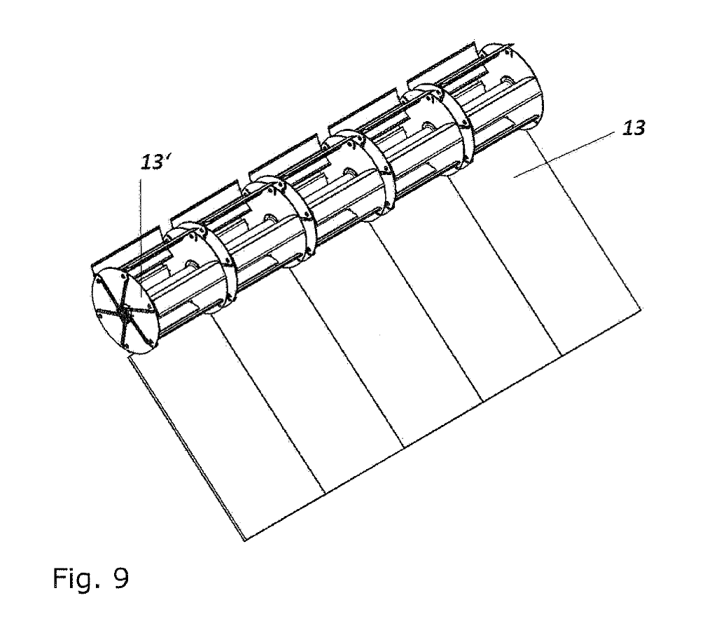

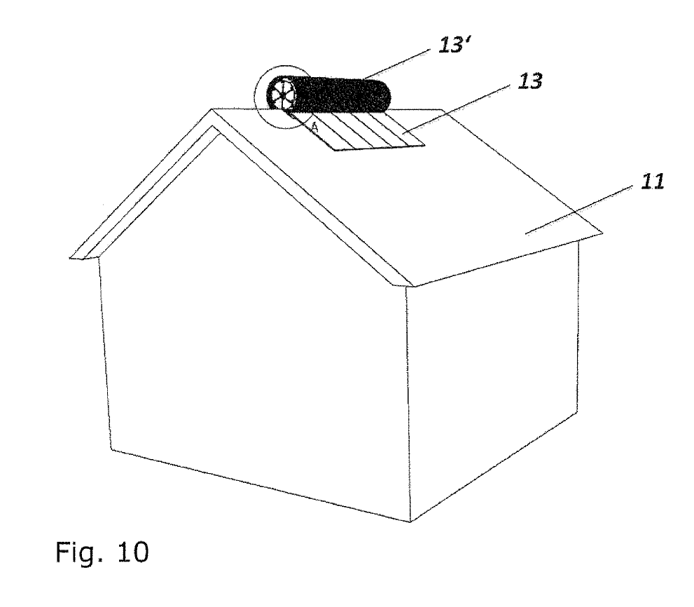

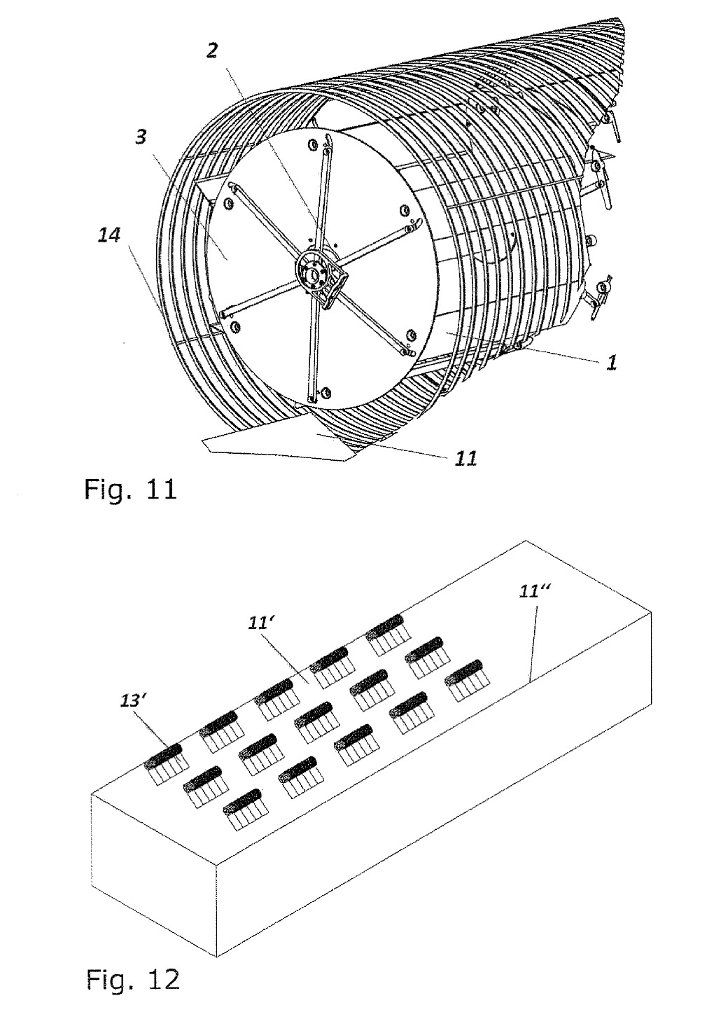

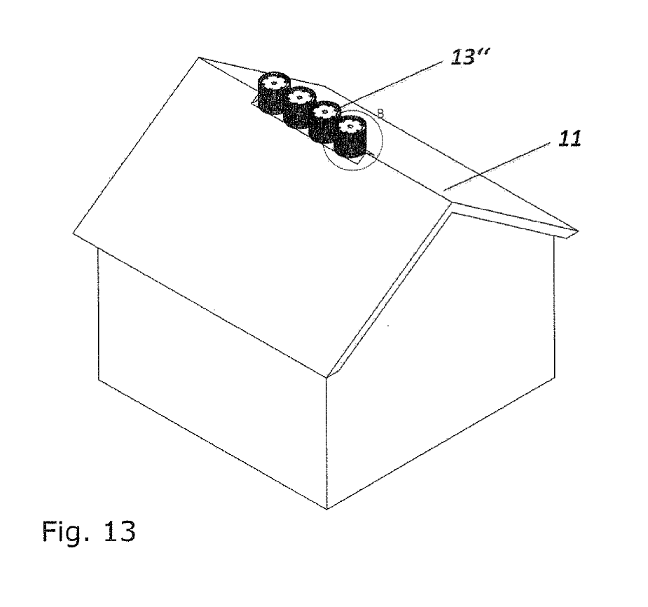

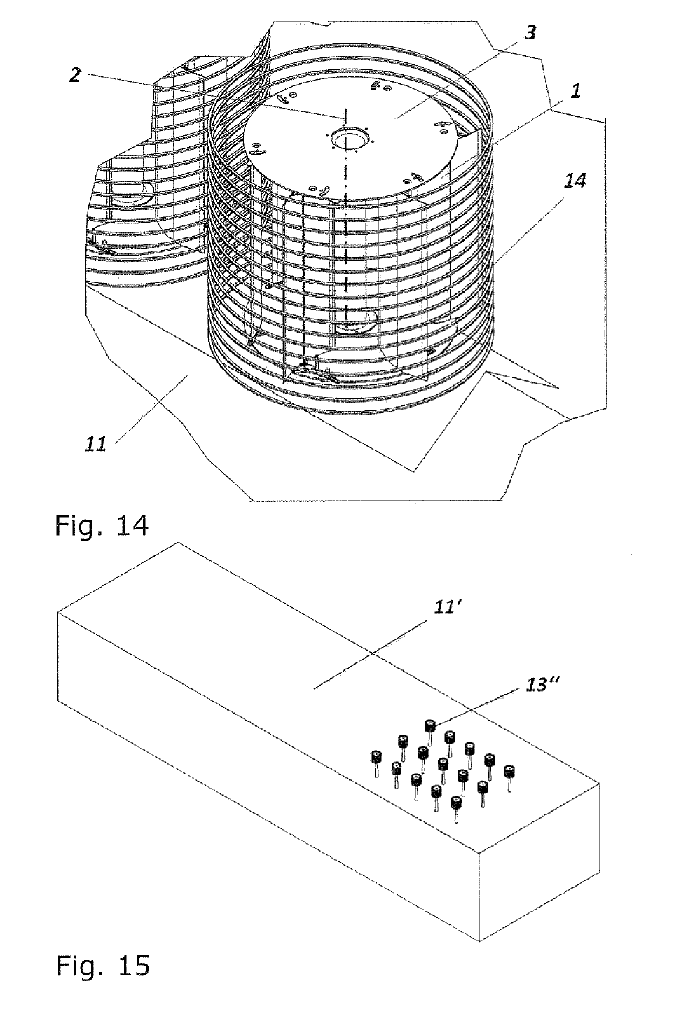

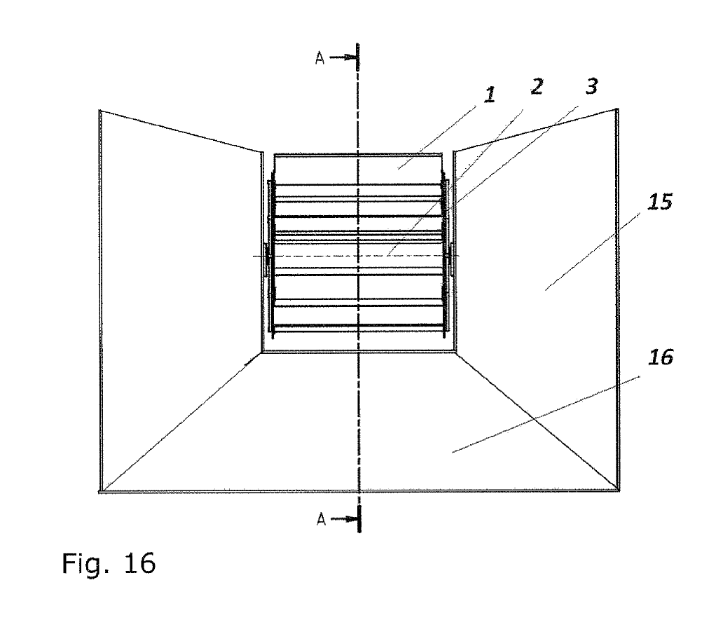

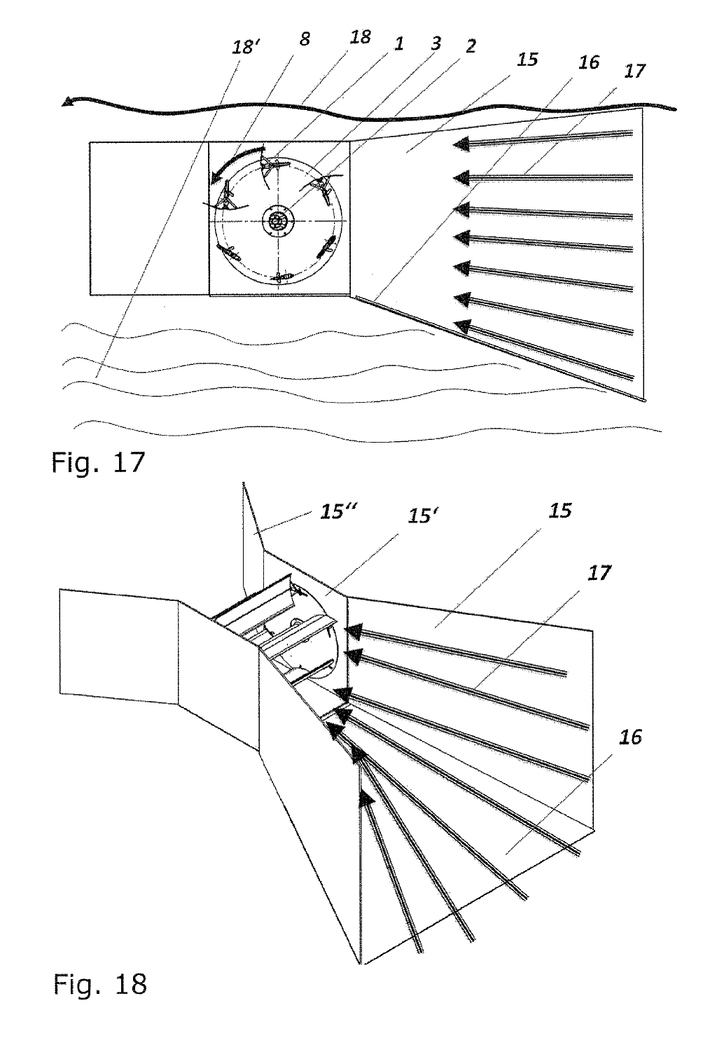

FIG. 1 illustrates a cyclogyro rotor of the kind mentioned above in an isometric view, FIG. 2 in FIG. 3 illustrate the cyclogyro rotor in a non-frontal view and side view, FIG. 4 illustrates the cyclogyro rotor with closed wing profiles in a sectional view along the line B-B in FIG. 2 with an illustration of the wind direction and the direction of rotation of the rotor, FIG. 5 illustrates the cyclogyro rotor with open wing profiles in a quadrant in a sectional view with the illustration of the wind direction and the direction of rotation of the rotor, FIG. 6 illustrates the cyclogyro rotor with open wing profiles in a quadrant in an isometric view, FIG. 7 illustrates an embodiment of the building with a wind accelerator in the gable region in an isometric view, FIG. 8 illustrates the variant of the building with a wind accelerator and the progression of the flow lines, FIG. 9 illustrates an embodiment of the cyclogyro rotor in a horizontal axial alignment as a wind power plant in combination with a photovoltaic or solar panel, FIG. 10 illustrates a horizontal embodiment of the cyclogyro rotor as a wind power plant integrated in the gable construction of a building and combined with photovoltaic or solar panels, FIG. 11 illustrates a detail of FIG. 10, FIG. 12 illustrates an embodiment of a horizontal wind power plant on a flat roof, FIG. 13 illustrates a vertical embodiment of the cyclogyro rotor as a wind power plant integrated in the gable construction of a building, FIG. 14 illustrates a detailed view of FIG. 13, FIG. 15 illustrates an arrangement of the vertical embodiment as a wind power plant with protective housing on a building with a flat roof, FIG. 16 illustrates an embodiment of the cyclogyro rotor as a hydroelectric power plant in a front view, FIG. 17 illustrates the same embodiment of the cyclogyro rotor as a wind power plant in a sectional view, FIG. 18 illustrates the embodiment of the cyclogyro rotor as a wind power plants in an isometric view.

FIG. 1 illustrates a preferred embodiment of a cyclogyro rotor in accordance with the invention in a first operating mode in an isometric view, consisting of several, preferably six, rotor blades 1 which are pivotably mounted in pivot bearings 4 in the lateral discs 3, a rotational axis 2, a shaft 2′, adjusting bars 5 for the cyclic rotor blade adjustment via links 5a, a central offset 7 for predetermining the direction and magnitude of the rotor blade adjustment, and a central rotor bearing 6. The shaft 2′ and the lateral discs 3 form the rotor body.

FIG. 2 illustrates the embodiment of FIG. 1 in the direction of flow and FIG. 3 illustrates the embodiment of FIG. 1 and FIG. 2 in a side view.

FIG. 4 illustrates the preferred embodiment of the cyclogyro rotor in a sectional view along the line of intersection B-B of FIG. 2 in the first operating mode. The flow medium of air or water, which impinges on the cyclogyro rotor in the direction 9, makes the rotor rotate in a direction 8. The geometry of the rotor blade 3 is a fully symmetric enclosed profile which is optimally arranged for higher flow velocities. The individual rotor blades 1 are pivoted about a main pivoting axis 1a in order to generate an optimal torque.

FIG. 5 illustrates the above embodiment of the cyclogyro rotor in a sectional view analogously to FIG. 4 in a second operating mode. The flow medium of air or water, which impinges on the cyclogyro rotor in the direction 9, makes the rotor rotate in the direction of the arrow 8. The geometry of the rotor blade 1 is a fully symmetric profile which consists of two sections 1′, 1″, which in the forward-wave flow region can be folded up along the further pivoting axis 1b for the purpose of increasing the flow resistance and which are closed in the backward-wave flow region, which is optimal for low flow velocities. As a result, the rotor is made to rotate already at low flow velocities, which allows low start-up and coupling speeds.

A centrifugal clutch, which is not illustrated here in detail, produces the cyclic opening and closing of the sections 1′ and 1″ via a mechanical coupling 1′″ and 5′.

FIG. 6 illustrates the embodiment of the cyclogyro rotor of FIG. 5 in an isometric view.

FIG. 7 illustrates a wind power plant with a wind accelerator 10 on a roof construction 11 of a building in the region of the ridge 11a of the roof

FIG. 8 illustrates the effect of the wind accelerator 10 on a roof construction 11 of a building on the basis of flow lines 12. In the region of the highest area of the building (ridge 11a of the roof), a flow concentration is produced and an increase in the wind velocity occurs.

FIG. 9 illustrates a further embodiment of a horizontally aligned wind power plant with rotors 13′ which are combined with photovoltaic or solar panels 13 and are a component of the wind accelerator.

FIG. 10 illustrates a further preferred embodiment of a horizontally aligned wind power plant with rotors 13′ integrated in the roof construction 11 of a building and combined with photovoltaic or solar panels 13.

FIG. 11 illustrates a detailed view (A) of FIG. 10 of a horizontally aligned wind power plant 13′ with a protective apparatus 14 against inadvertent contact of the moved parts with persons or flying birds and as a protection of the moved parts of the wind power plant against flying objects.

FIG. 12 illustrates a further preferred embodiment of horizontally aligned wind power plants with rotors 13′ which are erected on flat roofs 11′ of buildings. Accelerated wind velocities occur especially close to building edges 11″, which can be utilized optimally in the case of a respective arrangement of the wind power plants with rotors 13′.

FIG. 13 illustrates a further preferred embodiment of a wind power plant 13″ arranged as a vertically aligned installation which is integrated in the gable construction of the roof 11 of a building. In this embodiment, the power of the wind power plant is virtually independent of the direction of the incoming air.

FIG. 14 illustrates a detailed view (B) of FIG. 13 of the vertically aligned wind power plant with rotors 13″ with a protective apparatus 14 against inadvertent contact of the moved parts with persons or flying birds and as a protection of the moved parts of the wind power plant against flying objects.

FIG. 15 illustrates a further preferred embodiment of a vertically aligned wind power plant with rotors 13″ erected on a flat roof construction of buildings.

FIG. 16 illustrates a front view of a preferred embodiment of a hydroelectric power plant, consisting of a cyclogyro rotor integrated in a flow apparatus 15, 16.

FIG. 17 illustrates a preferred embodiment of a hydroelectric power plant, consisting of the cyclogyro rotor integrated in a flow apparatus 15, 16 in a sectional view along the line of intersection A-A of FIG. 16, wherein the water flow 17 flows against the cyclogyro rotor which is situated beneath the water surface 18 in the flow 18′.

FIG. 18 illustrates an isometric view of a preferred embodiment of a hydroelectric power plant, including the cyclogyro rotor integrated in a flow apparatus 15, 16.

1-38. (canceled)

39. A turbomachine, comprising:
a substantially cylindrical rotor with a rotor body having a rotational axis and which is moveable in a direction perpendicularly to the rotational axis, a plurality of rotor blades arranged in the rotor body parallel to the rotational axis, each rotor blade having rotor blade sections pivotable about a pivot axis which is parallel to the rotational axis, and an adjusting device for cyclically adjusting the rotor blades and which is operable between a first operating mode in which the rotor blades are cyclically pivoted in their entirety, and a second operating mode in which the sections of the rotor blades are pivoted cyclically against each other.

40. The turbomachine of claim 39, wherein the rotor blades comprise wing profiles which are divided in the longitudinal direction to form the rotor blade sections.

41. The turbomachine of claim 40, wherein the rotor blades comprise a profile nose and a second pivot axis arranged in the profile nose.

42. The turbomachine of claim 40, wherein the wing profiles are arranged symmetrically and division of the rotor blades is provided in an axis of symmetry so that the rotor blade sections are symmetric with respect to each other.

43. The turbomachine of claim 39, wherein the rotor blade sections are moveable from a first position in which they rest in a compact fashion on each other to a second position in which they form the rotor blade.

44. The turbomachine of claim 39, wherein a pivot angle of the rotor blade sections is between 135° and 180°.

45. The turbomachine of claim 39, further comprising a flow guide housing having an inflow funnel upstream of the rotor and a diffuser downstream of the rotor.

46. The turbomachine of claim 39, further comprising a centrifugal-force adjusting apparatus to switch into the first operating mode above a predetermined speed of the rotor and into the second operating mode below the predetermined speed of the rotor.

47. The turbomachine of claim 39, wherein the adjusting device is arranged to cyclically pivot the rotor blades in their entirety and simultaneously cyclically pivot the rotor blade sections of the rotor blades.

48. A wind power plant, comprising:
at least one turbomachine arranged on a roof of a structure and which has a substantially cylindrical rotor with a rotor body having a rotational axis and which is moveable in a direction perpendicularly to the rotational axis, a plurality of rotor blades arranged in the rotor body parallel to the rotational axis, each rotor blade having rotor blade sections pivotable about a pivot axis which is parallel to the rotational axis, and an adjusting device for cyclically adjusting the rotor blades and which is operable between a first operating mode in which the rotor blades are cyclically pivoted in their entirety, and a second operating mode in which the sections of the rotor blades are pivoted cyclically against each other,
wherein the rotor is arranged in a region of a ridge of the roof and has an axis which is parallel to the ridge.

49. The wind power plant of claim 48, wherein the rotor is arranged directly beneath a solar power plant.

50. The wind power plant of claim 48, wherein the rotor has a vertical axis.

51. A method for operating a turbomachine, comprising:
cyclically adjusting rotor blades of a rotor at least partially by cyclically folding up and folding down of rotor blade sections which form the rotor blades, the rotor blade sections being pivotable about a pivot axis which is parallel to a rotational axis of the rotor;
cyclically pivoting the rotor blades in their entirety in a first operating mode; and
cyclically pivoting the respective rotor blade sections against each other in a second operating mode.

52. The method of claim 51, wherein:
the first operating mode is chosen at inflow velocities above a predetermined threshold value; and
the second operating mode at inflow velocities beneath a predetermined threshold value.

53. The method of claim 51, further comprising switching between the first operating mode and the second operating mode occurs as a function of the rotor speed.

54. The method of claim 51, wherein:
the first operating mode is chosen at rotational speeds above a predetermined threshold value; and
the second operating mode is chosen at rotational speeds beneath a predetermined threshold value.

55. The method of claim 51, wherein the rotor blades are both cyclically adjusted in their inclination and also folded up and down according to a characteristic map.

56. The method of claim 51, wherein the rotor blades are folded up over an angle at circumference which is between 110° and 150°.

57. The method of claim 51, wherein:
an energy yield is increased by heating a flow medium; and
the heating occurs such that incoming air is guided over a solar power plant.
